(19) United States
(12) Patent Application Publication
(10) Pub. No.: US 2014/0087870 A1
(43) Pub. Date: Mar. 27, 2014

(54) METHOD FOR CONSTRUCTING GEOSOCIAL GAMES WITH THE AID OF PARTICIPANT TERMINALS, THE INTERNET AND MOBILE COMMUNICATION TAKING INTO CONSIDERATION A CUMULATIVE COLLECTIVE APPROACH

(71) Applicant: Oleg Leonidovich Savchuk, Cherkassy (UA)

(72) Inventor: Oleg Leonidovich Savchuk, Cherkassy (UA)

(21) Appl. No.: 13/824,881

(22) PCT Filed: Oct. 18, 2010
(86) PCT No.: PCT/UA2010/000076

§ 371 Date: Sep. 4, 2013

(30) Foreign Application Priority Data
Aug. 3, 2010 (UA) U 2010 09696

(51) Int. Cl. A63F 13/12

(52) U.S. Cl. CPC A63F 13/12
USPC 463/31

(57) ABSTRACT

A system firstly for creation of new, or expansion of existing, electronic networks organizing, searching, and displaying information, and secondly, for different social groups to participate in intellectual competitions regardless of geographic location or the amount of participants, and for operators, such as arbiters or referees/judges, simultaneously, using appropriate software interfaces, to calculate, control, and analyze the participants' cumulative, collective moves, and game results.

### CROSS-REFERENCE TO RELATED APPLICATIONS

The present invention claims priority to PCT application PCT/UA2010/000076 filed Oct. 18, 2010 based on Ukranian patent application u2010 09696 filed Aug. 3, 2010.

### FIELD OF INVENTION

The invention relates to electronic networks, and can be used while designing new, or to enhance the abilities of existing networks to post, search, and display information with the goal of allowing various social groups to participate in intellectual competitions regardless of the geographic location, means of communicating with the server, and the number of participants.

### BACKGROUND

“Method for developing social games using mobile communications”, Ukrainian Patent No49124 from 26 Apr. 2010 by author Savchuk is known in the art. A shortcoming of the invention is the lack of consideration of geographical locations of players and the ability to independently calculate, control, and analyze the cumulative collective move by arbiters and judges. This method is the most similar in its technical nature and is chosen as prototype.

### SUMMARY OF THE INVENTION

A method for constructing social games with the aid of mobile communication, in which the results of a collective run which are produced with the aid of bilateral information interchange via SMS, MMS, voice messages, tones, USSD, and Internet messages, together with data relating to the geographical location of the players, are collated, analyzed and processed on a server, are calculated, monitored and analyzed with the aid of operators, whereupon competitions in the form of one or more results of the collective run are issued to participant terminals. The claimed method provides the possibility of different social groups taking part in intellectual competitions independently of the geographical location and number of participants.

### BRIEF DESCRIPTION OF THE DRAWINGS

FIG. 1: A schematic block-diagram of the geosocial game according to the present invention.

### DETAILED DESCRIPTION OF THE PREFERRED EMBODIMENT

The goal of the present invention is simultaneously enabling the joint participation in intellectual competitions of unlimited amounts of participants, expansion of ways to process participant moves, with consideration, if necessary, for the geographical location of the participants, with simultaneous independent calculation and control of their moves to obtain the cumulative collective move, with possible involvement of arbiters and judges/referees.

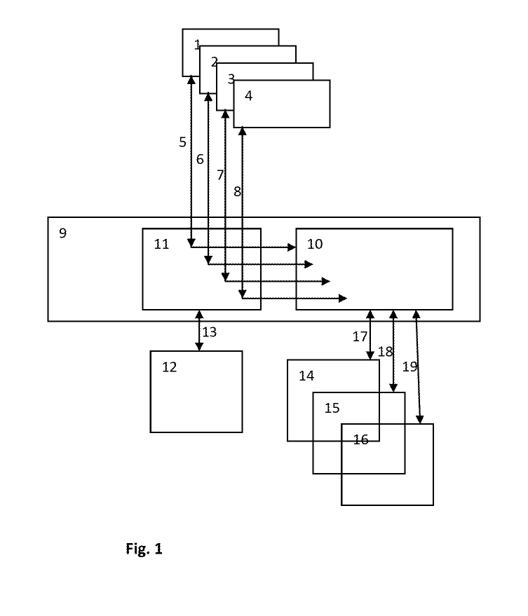

The claimed method for constructing social games is implemented by sending text, graphic, audio, video, or graphic code messages, by sending SMS, MMS, voice, tone, and USSD messages, or through the internet, using subscriber terminals 1-4 (FIG. 1) with placement of information via links 5-8 on web server 9 and the ability to display it on a website 10, which is unique because the data, received via two-way data communication 5-8 through SMS, MMS, voice, tone, USSD, and internet messages, together with data on the geographic location of players is gathered, stored, analyzed, and processed on a dedicated server 9 using corresponding software 11, simultaneously, when necessary, with corresponding interfaces 12 independently calculated, controlled, analyzed by an operator and transferred to the server 9 via link 13, after which they are output on the competition participants' terminals 14-16 via links 17-19 in the form of one or several results of the collective move. Obviously, the number of participants is not limited to four and the number of competitors is not limited to three such as on the FIG. 1. This is done only for illustration. Any number of participants and competitors may participate in the game.

The noted features are necessary and sufficient to obtain a technical result. The technical result of the invention is to create new, or expand existing electronic networks' capabilities to provide additional ways to search for and display information, with the goal of allowing various social groups to participate in intellectual competitions regardless of geographic location or amount of participants, with simultaneous independent calculation, control, and analysis of the cumulative collective move using arbiters and referees/judges. The collective move is the most recurring move of the game participants. The game participants do not participate in forming the collective move and displaying it to the competitor, they only participate in contributing their own moves to the collective move.

The method for constructing social game using mobile communications is implemented in the following way:

Mobile or internet network subscribers, wishing to participate in the social game, have the ability to either take part in the current game or start a new game. The server, directing the social game using appropriate software, collects, stores, and analyzes data, received from player's mobile or internet terminals, in the form of moves or answers, provides results in the form of one or, if the game allows, several cumulative collective moves, transfers the right to act to the other side or sides, and also displays the results by changing the game state, such as moving figures/pieces on a game board.

At the same time that the data is automatically processed by the software system's dedicated interfaces, data is calculated, controlled, and analyzed with the help of an operator, such as an arbiter or referee/judge.

A system constructed this way allows, firstly, creation of new, or expansion of existing electronic networks' capabilities of organizing, searching, and displaying information, and secondly, allows different social groups to participate in intellectual competitions regardless of geographic location or the amount of participants, and allows operators, such as arbiters or referees/judges, simultaneously, using appropriate software interfaces, to calculate, control, and analyze the participants' cumulative, collective moves and game results.

What is claimed is:

1. A method of constructing social games comprising: mobile communications via transfer of text, graphics, audio, video, or program code announcements by sending SMS, MMS, voice, tone, and USSD messages from the participant's mobile phones, with an additional collected information posted on an internet server and optionally displayed on a website, wherein the information, received through two-way communication through SMS, MMS, voice, tone, USSD, and internet messages and information about geographic locations of players are collected, stored, analyzed on a dedicated server using appropriate applications, simultaneously, as necessary, by means of corresponding software interfaces, independently calculated, controlled, analyzed by an operator, after which they're output on at least one competitor's terminal in a form of one or several results of the collective move that is the most recurring move of the game participants, wherein the collective move displayed on the competitor's terminal not by one of the game participants.

2. The method of claim 1, further comprising: at least two competitors and the game participants participate in a number of games corresponding to the number of competitors; wherein each competitor receives collective moves from all participants based on the most recurring move of the game participants.
